(19) United States
(12) Patent Application Publication
(10) Pub. No.: US 2007/0216056 A1
(43) Pub. Date: Sep. 20, 2007

(54) METHOD FOR PRODUCING A THERMOPLASTIC RESIN MOLDED ARTICLE

(75) Inventor: Satoshi Hanada, Ichihara-shi (JP)

Correspondence Address: SUGHRUE MION, PLLC, 2100 PENNSYLVANIA AVENUE, N.W., SUITE 800, WASHINGTON, DC, 20037, US

(73) Assignees: SUMITOMO CHEMICAL COMPANY, LIMITED, Tokyo (JP); SUMIKA PLASTECH CO., LTD., Tokyo (JP)

(21) Appl. No.: 11/685,255

(22) Filed: Mar. 13, 2007

(30) Foreign Application Priority Data
Mar. 16, 2006 (JP) 2006-072567

(51) Int. Cl. B29C 44/04

(52) U.S. Cl. 264/45.1

(57) ABSTRACT

The invention relates to a method for producing a molded article including a thermoplastic resin foamed substrate and a thermoplastic resin functional member which is joined to and projects from the foamed substrate. A molten thermoplastic resin is injected into a mold cavity for forming the functional member while the cavity is sealed with a thermoplastic resin foamed substrate. In the method, compressed gas is supplied into the cavity before the injection of the molten thermoplastic resin is completed.

### BACKGROUND OF THE INVENTION

1. Technical Field

The present invention relates to methods for producing thermoplastic resin molded articles.

2. Description of the Related Art

Expansion molded articles produced by molding thermoplastic resin foamed sheets are used for various applications such as automotive components and building materials because they are lightweight and excellent in recyclability, thermal insulating properties, etc. Thermoplastic resin molded articles having a structure such that a non-foamed thermoplastic resin functional member, such as rib, boss and hook, is welded to an expansion molded body can also be used as automotive interior or exterior components, etc. As a method for producing such thermoplastic resin molded articles, a method comprising the following steps (1) to (4) are known (see, for example, Japanese Unexamined Patent Application Publication No. 2001-121561):

(1) feeding a foamed sheet made of thermoplastic resin shaped in a predetermined form between a pair of male and female mold halves, at least one mold half having in the molding surface a concave portion corresponding to the shape of the functional member;

(2) closing the mold halves, to stop the opening of said concave portion with the foamed sheet made of thermoplastic resin;

(3) feeding the thermoplastic resin in a molten state to said concave portion through a resin passageway leading to said concave portion and provided in the mold halves, while the mold halves are closed to stop the opening of the concave portion with the foamed sheet made of thermoplastic resin, to fuse the thermoplastic resin integrally to the foamed sheet made of thermoplastic resin to form the thermoplastic resin-molded article; and

(4) cooling the thermoplastic resin-molded article formed in step (3) and removing it from the mold halves.

### SUMMARY OF THE INVENTION

When a thermoplastic resin molded article having a complex shape is to be produced by the above-cited method, for example, when a functional member is to be formed at a curved portion of a molded article, a molten thermoplastic resin fed for forming a functional member sometimes leaks out of a concave portion of a mold. As a method for preventing a molten thermoplastic resin from leaking out, a method in which a pair of molds are clamped with a high clamping force is well known. However, if, in the above-cited method, the molds are closed with a high clamping force, the thermoplastic resin foamed sheet may subside into the concave portion of the mold and, as a result, a recess may appear in the surface opposite to the site where the functional member is welded, resulting in a failure to yield a molded article with good appearance.

An object of the present invention is to provide a method for producing a molded article comprising a thermoplastic resin foamed substrate and a thermoplastic resin functional member which is joined to and projects from the foamed substrate.

The present invention offers a method for producing a molded article comprising a thermoplastic resin foamed substrate and a thermoplastic resin functional member which is joined to and projects from the foamed substrate, the method comprising the following steps (1) to (8) that are executed by use of a molding machine comprising a first mold which has a first mold surface having a recessed portion defining a cavity for forming the functional member therein and which is configured so that compressed gas and thermoplastic resin in a molten state can be supplied into the cavity and a second mold which has a second mold surface and which is arranged with the second mold surface facing the first mold surface:

(1) a step of placing a foamed substrate made of thermoplastic resin between the first mold and the second mold;

(2) a step of supplying a compressed gas into the cavity;

(3) a step of closing the first mold and the second mold while the foamed substrate is located between the first mold and the second mold;

(4) a step of bringing the foamed substrate into contact with a portion other than the recessed portion of the first mold surface, thereby closing the cavity with the foamed substrate and the first mold surface;

(5) a step of stopping the supply of the compressed gas into the cavity;

(6) a step of supplying a thermoplastic resin in a molten state into the cavity to join it to the foamed substrate by welding and simultaneously form a functional member from the thermoplastic resin, thereby forming a molded article comprising the foamed substrate and the functional member joined thereto;

(7) a step of stopping the supply of the thermoplastic resin in a molten state into the cavity; and

(8) a step of opening the first mold and the second mold and taking out the molded article.

The method of the present invention makes it possible to produce molded articles with good appearance in which no recess exists in the surface opposite to the site where a functional member has been welded.

### BRIEF DESCRIPTION OF THE DRAWINGS

FIG. 1 is a schematic diagram showing one embodiment of the method of the present invention.

FIG. 2 is a schematic diagram showing another embodiment of the method of the present invention.

FIG. 3 is a plan view showing a flat plate with a rib.

FIG. 4 is a cross-sectional view of the flat plate of FIG. 3 taken along the line (a) in FIG. 3.

FIG. 5 is a cross-sectional view of a mold having a cavity for forming a functional member.

The signs in the drawings have meanings shown below: 1: foamed sheet shaped in predetermined shape; 2: clamp frame; 3: first mold; 4: compressed gas passage; 5: resin passage; 6: cavity; 7: second mold; 8: functional member (rib); 9: molded article (flat plate); 10: foamed sheet softened by heat; 11: first mold; 12: second mold; 13: width of cavity opening; 14: width of cavity bottom; 15: depth of cavity; 16: length of rib.

### DESCRIPTION OF THE PREFERRED EMBODIMENTS

The present invention offers a method for producing a molded article comprising a thermoplastic resin foamed substrate and a thermoplastic resin functional member which is joined to and projects from the foamed substrate. This method is executed by use of a molding machine comprising a first mold which has a first mold surface having a recessed portion defining a cavity for forming the functional member therein and which is configured so that compressed gas and thermoplastic resin in a molten state can be supplied into the cavity and a second mold which has a second mold surface and which is arranged with the second mold surface facing the first mold surface. In the following description, the first mold and the second mold are sometimes collectively called a pair of molds. The first and second molds may be various combinations such as a combination of a male mold and a female mold, a combination of two female molds and a combination of two flat molds.

The first mold, which has a cavity for forming therein a functional member, has inside a compressed gas passage through which compressed gas will be supplied into the cavity and a resin passage through which molten thermoplastic resin will supplied into the cavity. One end of each of the passages opens in the recessed portion of the mold surface of the first mold, namely the first mold surface. The location and shape of the recessed portion formed in the first mold surface are not particularly restricted. A mold having a recessed portion provided in conformity with the location and shape of the functional member in an intended product is used. The molded article to be produced by the method of the present invention may have either one functional member or two or more functional members. When a molded article having one functional member is produced, a first mold having one cavity for forming a functional member is used. When a molded article having two or more functional members is produced, a first mold having cavities the number of which is equal to that of the functional members to be formed is used. While the first and second molds have no particular limitations on their material, they are normally made of metal from the viewpoints of dimensional stability, durability and thermal conductivity. From the cost and weight points of view, the molds are preferably made of aluminum. Both the molds are preferably structured so that the temperature thereof can be controlled with a heater or heat medium. For preventing the foamed substrate from deforming, the mold surfaces of the molds are preferably adjusted within a range of from 20 to 80° C., and more preferably from 30 to 60° C. during the production of a thermoplastic resin molded article.

The molten thermoplastic resin supplied into the cavity through a passage provided in the first mold is cooled and forms a functional member. In the present invention, the functional member is a component which has been formed on the foamed substrate to project therefrom. Specific examples thereof include a rib that reinforces a thermoplastic resin molded article, and a boss, clip, hook and the like which fix, joint or attach the thermoplastic resin molded article to another object.

Each of the first mold and the second mold used in the present invention may be a mold having a mold surface through which compressed gas can be supplied or air suction can be executed. For example, by using a first mold in which air suction can be executed through a portion other than the recessed portion of the first mold surface and a second mold in which compressed gas can be blown through the second mold surface and by sucking through the first mold surface and simultaneously blowing compressed gas through the second mold surface during a molding process, it is possible to force a foamed substrate placed between the first and second molds to attach firmly to the first mold surface. In addition, when a molten thermoplastic resin is supplied into the cavity inside the recessed portion of the first mold, it is possible to surely prevent the resin from leaking out of the cavity.

The method of the present invention is a method in which the following steps (1) through (8) are executed by use of a molding machine having a pair of molds like those described above:

(1) a step of placing a foamed substrate made of thermoplastic resin between the first mold and the second mold;

(2) a step of supplying a compressed gas into the cavity;

(3) a step of closing the first mold and the second mold while the foamed substrate is located between the first mold and the second mold;

(4) a step of bringing the foamed substrate into contact with a portion other than the recessed portion of the first mold surface, thereby closing the cavity with the foamed substrate and the first mold surface;

(5) a step of stopping the supply of the compressed gas into the cavity;

(6) a step of supplying a thermoplastic resin in a molten state into the cavity to join it to the foamed substrate by welding and simultaneously form a functional member from the thermoplastic resin, thereby forming a molded article comprising the foamed substrate and the functional member joined thereto;

(7) a step of stopping the supply of the thermoplastic resin in a molten state into the cavity; and

(8) a step of opening the first mold and the second mold and taking out the molded article.

The timing of the execution of each of steps (1) through (8) is not particularly restricted if the supply of the compressed gas into the cavity is executed before the completion of the supply of the molten thermoplastic resin into the cavity and the molten thermoplastic resin supplied into the cavity is prevented from leaking out of the cavity. In order to prevent the molten thermoplastic resin from leaking, it is necessary to start step (6) before the completion of step (4) and to complete step (7) before starting step (8). Some of the steps may be executed simultaneously. For example, steps (2), (3) and (4) may be executed simultaneously. In this embodiment, these three steps are executed, for example, in the following fashion. While a foamed substrate is held between the first mold and the second mold, compressed gas is supplied into the cavity defined inside the recessed portion of the first mold surface and simultaneously the first and second molds are closed. By execution of these operations, the foamed substrate is brought into contact with a portion other than the recessed portion of the first mold surface and, thereby, the cavity is sealed with the foamed substrate and the first mold surface.

In another embodiment, the first and second molds are closed and then compressed gas is supplied into the cavity inside the recessed portion of the first mold surface. In such an embodiment, for example, step (3) and step (4) are executed after step (1). Subsequently, step (2) and step (5) are executed successively, and then step (6), step (7) and step (8) are executed in this order.

When a mold in which air suction can be executed through a portion other than the recessed portion of the mold surface is used as the first mold and a mold in which compressed gas can be blown through the mold surface is used as the second mold, step (4) may be executed in the following manner. Air suction is executed through a portion other than the recessed portion of the first mold surface of the first mold and simultaneously compressed gas is blown through the second mold surface of the second mold. By execution of these operations, the foamed substrate is brought into contact with a portion other than the recessed portion of the first mold surface and, thereby, the cavity is sealed with the foamed substrate and the first mold surface.

When air suction is executed through a mold surface, it is desirable to conduct the air suction so that the degree of vacuum in the gap between the mold surf ace and the foamed substrate may fall within the range of from −0.05 MPa to −0.1 MPa. The degree of vacuum as referred to herein means the pressure in the gap between the mold surface and the foamed substrate expressed on the basis of the atmospheric pressure. For example, “the degree of vacuum is −0.05 MPa” means that the difference between the atmospheric pressure and the pressure in the sucked gap between the foamed substrate and the mold surface is 0.05 MPa. The degree of vacuum is detected with a detector provided in a vacuum suction passage provided in the mold. When compressed gas is blown through a mold surface, the compressed gas is desirably blown so that the pressure in the gap between the mold surface and the foamed substrate may fall within the range of from 0.05 MPa to 0.7 MPa.

In a possible embodiment of the present invention, a thermoplastic resin foamed substrate having been softened by heat is placed between the first and second molds and then the molds are closed. Thus, the foamed substrate is shaped into a desired shape. In such a case, it is desirable to adjust the mold closing pressure within the range of from 1 to 100 ton/m². In another possible embodiment, a thermoplastic resin foamed substrate shaped previously into a predetermined shape by a shaping method such as press moldings, vacuum forming, pressure forming and vacuum-pressure forming is used. In such a case, a pair of molds are used which are designed so that the cavity in a mold surface can be sealed with the thermoplastic resin foamed substrate shaped previously into a predetermined shape. For example, a thermoplastic resin foamed substrate is shaped into a predetermined shape by use of a pair of dummy molds the mold surface shapes of which are the same as those of the first and second molds to be used in the process of forming a functional member except that the mold corresponding to the first mold has no recessed portion in its mold surface. Then, the shaped foamed substrate is moved to the space between first and second molds and, thereafter, the remaining steps are executed. Thus, a functional member is welded to the foamed substrate.

In the present invention, by increasing the pressure within a cavity for forming a functional member by supplying compressed gas into the cavity before supplying a molten thermoplastic resin into the cavity, it is possible to prevent a foamed substrate from subsiding into the cavity. This makes it possible to produce molded articles with good appearance which have no recess in the surface opposite to a site where a functional member is welded. While the compressed gas supplied into the cavity is not particularly restricted as long as it can achieve intended objects, it preferably has a pressure of from 0.05 to 1 MPa, and more preferably from 0.1 to 0.7 MPa. It is noted that the foamed substrate is not necessarily required to be in contact with the mold surface having the recessed portion during the supply of the compressed gas.

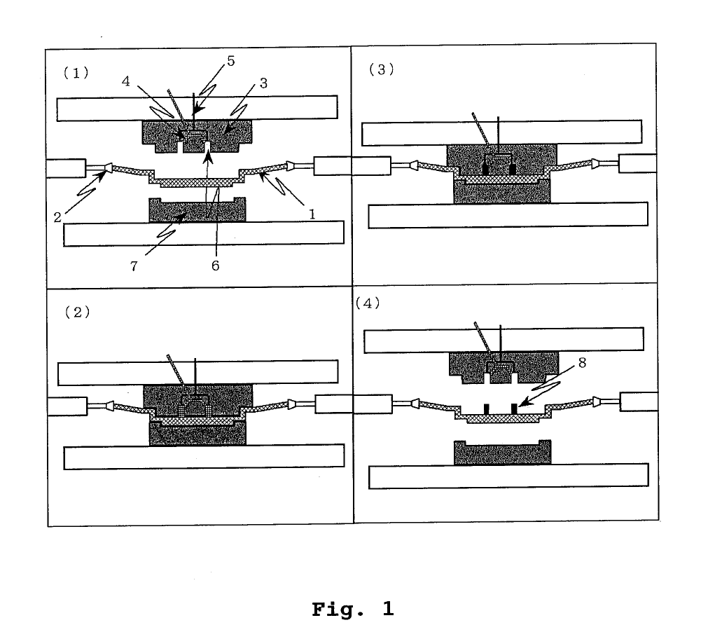

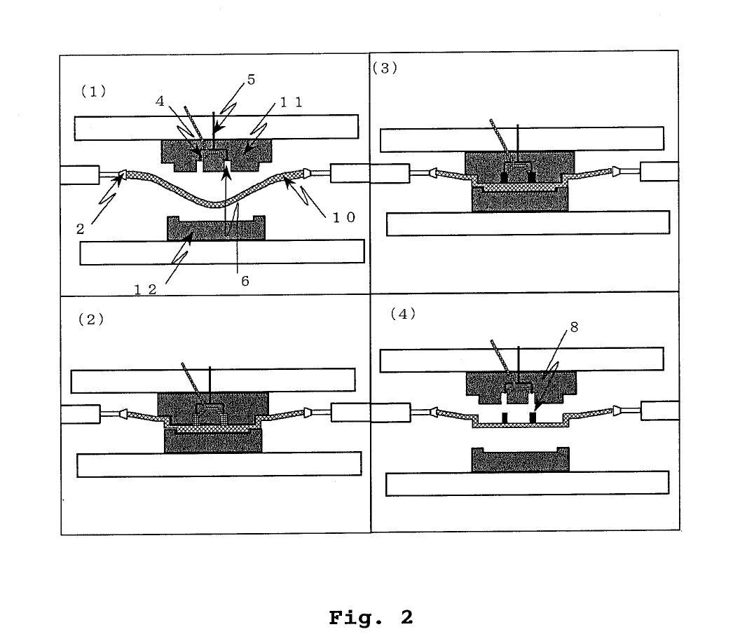

Specific examples of the method of the present invention are explained below with reference to FIGS. 1 and 2 below.

FIG. 1 is a diagram showing an example in which a foamed substrate shaped previously into a desired shape is used. FIG. 1(1) depicts a step of supplying a thermoplastic resin foamed substrate shaped previously into a predetermined shape between a first mold which has a first mold surface having a recessed portion defining a cavity for forming the functional member therein and which is configured so that compressed gas and thermoplastic resin in a molten state can be supplied into the cavity and a second mold which has a second mold surface and which is arranged so that the second mold surface faces the first mold surface. FIG. 1(2) shows a state where while compressed gas is supplied into the cavity in the first mold, the first and second molds are closed and, thereby, the opening of the cavity is sealed with the foamed substrate. FIG. 1(3) shows a state where after the supply of the compressed gas into the cavity is stopped, a molten thermoplastic resin is supplied into the cavity to be welded to the foamed substrate and, thereby, a molded article comprising the thermoplastic resin foamed substrate and a functional member joined to the foamed substrate is yielded. Thereafter, following the supply of the molten thermoplastic resin is stopped, the molds are opened and then the molded article is taken out. FIG. 1(4) shows this situation.

FIG. 2 shows an example in which a thermoplastic resin foamed substrate having been softened by heat is used. The method for heating the thermoplastic resin foamed substrate is not particularly restricted. For example, the foamed substrate may be heated with a heating device such as an infrared heater or hot air blowing. FIG. 2 shows a method using a machine similar to that used in the method depicted in FIG. 1. FIG. 2(1) shows a step of placing a thermoplastic resin foamed substrate having been softened by heat between the first and second molds. FIG. 2(2) depicts a state where while compressed gas is supplied into the cavity In the first mold, the first and second molds are closed and, thereby, the opening of the cavity is sealed with the foamed substrate. In this case, the mold closure is executed so that the foamed substrate is shaped into a predetermined shape. FIG. 2(3) and FIG. 2(4) are equivalent to FIG. 1(3) and FIG. 1(4). respectively.

Examples of the thermoplastic resin for forming the foamed substrate include olefin-based resin such as homopolymers of olefins having from 2 to 6 carbon atoms e.g. ethylene, propylene, butene, pentene and hexene and olefin copolymer produced by copolymerizing of two or more kinds of monomer selected from olefins having from 2 to 10 carbon atoms, ethylene-vinyl ester copolymer, ethylene-(meth)acrylic acid copolymer, ethylene-(meth)acrylic ester copolymer, ester resin, amide resin, styrenic resin, acrylic resin, acrylonitrile-based resin and ionomer resin. These resins may be used either solely or in a combination of two or more resins. Olefin-based resins are preferably used from the viewpoints of moldability, oil resistance and cost. Propylene-based resins are particularly preferably used from the viewpoint of rigidity and heat resistance of resulting molded articles.

Examples of the propylene-based resins include propylene homopolymers and propylene-based copolymers containing at least 50 mol % of propylene units. The copolymers may be block copolymers, random copolymers and graft copolymers. Examples of the propylene-based copolymers to be suitably employed include copolymers of propylene with ethylene or an α-olefin having 4 to 10 carbon atoms. Examples of the α-olefin having 4 to 10 carbon atoms include 1-butene, 4-methylpentene-1, 1-hexene and 1-octene. The content of the monomer units except propylene in the propylene-based copolymer is preferably up to 15 mol % for ethylene and up to 30 mol % for α-olefins having 4 to 10 carbon atoms. A single kind of propylene-based resin may be used. Alternatively, two or more kinds of propylene-based resin may also be used in combination.

When a long-chain-branching propylene-based resin or a propylene-based resin having a weight average molecular weight of 1×10⁵ or more is used in an amount of 50% by weight or more of the thermoplastic resin forming a foamed substrate, it is possible to produce a propylene-based resin foamed substrate containing finer cells. Non-crosslinked propylene-based resin is suitably used because it will hardly cause gelation during a recycling process.

By the long-chain branching propylene-based resin used herein is meant a propylene-based resin whose branching index [A] satisfies 0.20≦[A]≦0.98. One example of the long-chain branching propylene-based resins having a branching index [A] satisfying 0.20≦[A]≦0.98 is Propylene PF-814 available from SunAllomer Ltd.

The branching index quantifies the degree of long chain branching in a polymer and is defined by the following formula:
Branching index [A]=[η]Br/[η]Lin.
In the formula, [η]Br is the intrinsic viscosity of the long-chain branching propylene-based resin. [η]Lin is the intrinsic viscosity of a linear propylene-based resin made up of monomer units the same as those of the long-chain-branching propylene-based resin and having a weight average molecular weight the same as that of the long-chain branching propylene-based resin.

The intrinsic viscosity, which is also called “limiting viscosity number,” is a measure of the capacity of a polymer to enhance the viscosity of its solution. The intrinsic viscosity depends particularly on the molecular weight and on the degree of branching of the polymer molecule. Therefore, the ratio of the intrinsic viscosity of the long-chain branching polymer to the intrinsic viscosity of a linear polymer having a molecular weight equal to that of the long-chain branching polymer can be used as a measure of the degree of branching of the long-chain branching polymer. The intrinsic viscosity of a propylene-based resin can be determined by a conventional method such as the method described by Elliott et al., J. Appl. Polym. Sci., 14, 2947-2963 (1970). For example, the intrinsic viscosity can be measured at 135° C. by dissolving the propylene-based resin in tetralin or orthodichlorobenzene.

The weight average molecular weight (Mw) of a propylene-based resin can be determined by various methods commonly used. Particularly preferably employed is the method reported by M. L. McConnel et al. in American Laboratory, May, 63-75 (1978), namely, the low-angle laser light-scattering intensity measuring method.

One example of the method for producing a high-molecular-weight propylene-based resin having a weight average molecular weight of 1×10⁵ or more by polymerization is a method in which a high molecular weight component is produced first and then a low molecular weight component is produced as described in Japanese Unexamined Patent Application Publication No. 11-228629.

Among the long-chain-branching propylene-based resin and the high-molecular-weight propylene-based resin, preferred is a propylene-based resin having a uniaxial melt elongation viscosity ratio η₅/η_{0.1} of 5 or more, and more preferably 10 or more, measured under the conditions given below at about a temperature 30° C. higher than the melting point of the resin. The uniaxial melt elongation viscosity ratio is a value measured at an elongation strain rate of 1 sec⁻¹ using a uniaxial elongation viscosity analyzer (for example, a uniaxial elongation viscosity analyzer manufactured by Rheometrix), wherein η_{0.1} denotes a uniaxial melt elongation viscosity detected 0.1 second after the start of strain and η₅ denotes a uniaxial melt elongation viscosity detected 5 seconds after the start of strain. Use of a propylene-based resin having such a uniaxial elongation viscosity characteristic makes it possible to produce a foamed substrate which includes very fine bubbles.

The foaming agent for use in the preparation of the foamed substrate may be either a chemical foaming agent or a physical foaming agent. Moreover, both types of foaming agents may be used together. Examples of the chemical foaming agent include known thermally decomposable compounds such as thermally decomposable foaming agents which form nitrogen gas through their decomposition (e.g., azodicarbonamide, azobisisobutyronitrile, dinitrosopentamethylenetetramine, p-toluenesulfonyl hydrazide, p,p′-oxy-bis(benzensulphonyl hydrazide); and thermally decomposable inorganic foaming agents (e.g., sodium hydrogencarbonate, ammonium carbonate and ammonium hydrogencarbonate). Specific examples of the physical foaming agent include propane, butane, water and carbon dioxide gas. Among the foaming agents provided above as examples, water and carbon dioxide gas are suitably employed because foamed substrates will produce less deformation resulting from secondary foaming during the heating in a vacuum forming process and also because those agents are inert under high temperature conditions and inert to fire. While the amount of the foaming agent used is properly determined on the basis of the kinds of the foaming agent and resin used so that a desired expansion ratio is achieved, 0.5 to 20 parts by weight of foaming agent is usually used for 100 parts by weight of the thermoplastic resin.

While the method for preparing a foamed substrate is not particularly restricted, sheets produced by extrusion forming by use of a flat die (T die) or a circular die are preferred. A preferred method is one in which molten resin is extruded and simultaneously expanded through a circular die and then the resulting tube is stretched and cooled on a mandrel. When a foamed substrate is produced by extrusion, it is permitted that molten resin is extruded through a die, cooled to solidify, and then stretched. The foamed substrate used in the present intention may be either one having a single layer or one having two or more layers. From the viewpoint of cell breakage during the foamed substrate production, a multilayer-structure foamed substrate having non-foamed layers as its outermost layers is preferred. While resins such as those provided previously as examples of the thermoplastic resin for forming the foamed substrate can be used as the resins forming the non-foamed layers and the foamed layer, it is desirable that the resin of the non-foamed layers be of the same type as the resin of the foamed layer. For example, when the foamed layer is a propylene-based resin, it is desirable that the non-foamed layers also be a propylene-based resin. While particulars of the foamed substrate are not restricted, in most cases a foamed substrate having an expansion ratio of from 2 to 10 and an overall thickness of from 1 to 10 mm is used.

The foamed substrate used in the present invention may be a composite sheet composed of a monolayer or multilayer foamed sheet and another material laminated to the foamed sheet. Such a composite sheet can be produced by laminating a foamed sheet with another material by dry lamination, sandwich lamination, hot roll lamination and hot air lamination.

The material to be laminated to the foamed sheet may have a function of decoration, reinforcement, protection and the like. Examples of such a material include woven fabric, nonwoven fabric, sheet, film, foam and mesh. These may be made of thermoplastic resin such as olefin-based resin, vinyl chloride-based resin, styrene-based resin, rubber or thermoplastic elastomer such as polybutadiene and ethylene-propylene copolymers, cellulose fiber such as cotton, hemp and bamboo fiber. The material may be provided with three-dimensionally uneven patters, print or dyeing. The material may have either a single layer or multiple layers.

The foamed substrate used in the present invention may include additives. Examples of the additives include filler, antioxidants, light stabilizers, ultraviolet absorbers, plasticizers, antistatic agents, colorants, release agents, fluidizing agents and lubricants. Specific examples of the flller include inorganic fibers such as glass fiber and carbon fiber and inorganic particles such as talc, clay, silica, titanium oxide, calcium carbonate and magnesium sulfate.

In the present invention, while the thermoplastic resin to be used as the material forming the functional member is not particularly restricted, a resin which exerts good weldability to the thermoplastic resin forming the foamed substrate is chosen. A thermoplastic resin which is the same as or similar to the thermoplastic resin forming the foamed substrate is preferred from the viewpoint of welding strength to the foamed substrate. The thermoplastic resin for the functional member may also include various kinds of additives. Specific examples of the filler include inorganic fibers such as glass fiber and carbon fiber and inorganic particles such as talc, clay, silica, titanium oxide, calcium carbonate and magnesium sulfate.

### EXAMPLES

The present invention is explained below with reference to Example and Comparative Example, but the invention is not restricted to the Example.

### Example

A molded article was produced by a method illustrated in FIG. 2 by using a polypropylene foamed sheet with an expansion ratio of 3 and a thickness of 3 mm (commercial name: SUMICELLER; manufactured by Sumika Plastech Co., Ltd.) as a foamed substrate.

Molding of a flat plate with a rib was executed by use of a molding machine including:

a first mold (11) that had a mold surface with a recessed portion defining a cavity (6) for forming a rib and that was structured so that air suction can be executed through the mold surface, the cavity having an opening width (13) of 5 mm, a bottom width (14) of 4 mm, a depth (15) of 5 mm and a length of 370 as shown in FIG. 5; and

a second mold (12) capable of shaping a foamed substrate into a flat plate form. The first mold (11) had a compressed gas passage (4) and a resin passage (5) both leading to the cavity. The first mold (11) was controlled to a temperature of 60° C.

While a foamed sheet (10) was held with a clamp frame (2) of a vacuum forming machine equipped with an extruder (VAIM0301, manufactured by Sato Tekko Co., Ltd.), it was heated with a near-infrared heater so that its top surface came to have a temperature of 210° C., thereby being softened. The softened foamed sheet (10) was placed between the first mold (11) and the second mold (12) while being held with the clamp frame (2). Then, supply of compressed air with a pressure of 0.6 MPa through a compressed gas supply hole (not shown) located at the longitudinal end of the recessed portion via the compressed gas passage (4) in the first mold (11) was started and, simultaneously, the first mold (11) and the second mold (12) were closed until the clearance between their mold surfaces became 2.9 mm. Then, by execution of air suction through the mold surface of the second mold, a flat foamed substrate 2.9 mm in thickness was produced from the foamed sheet (10).

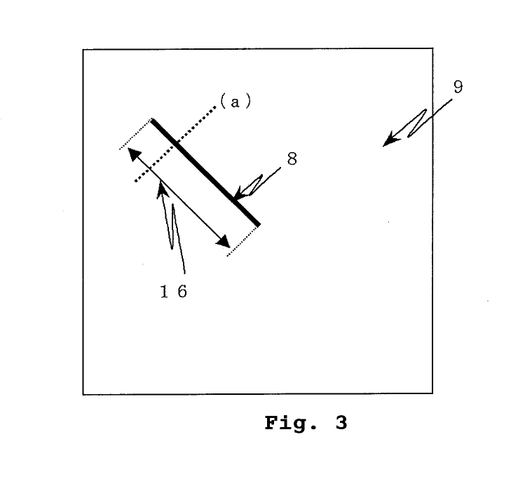

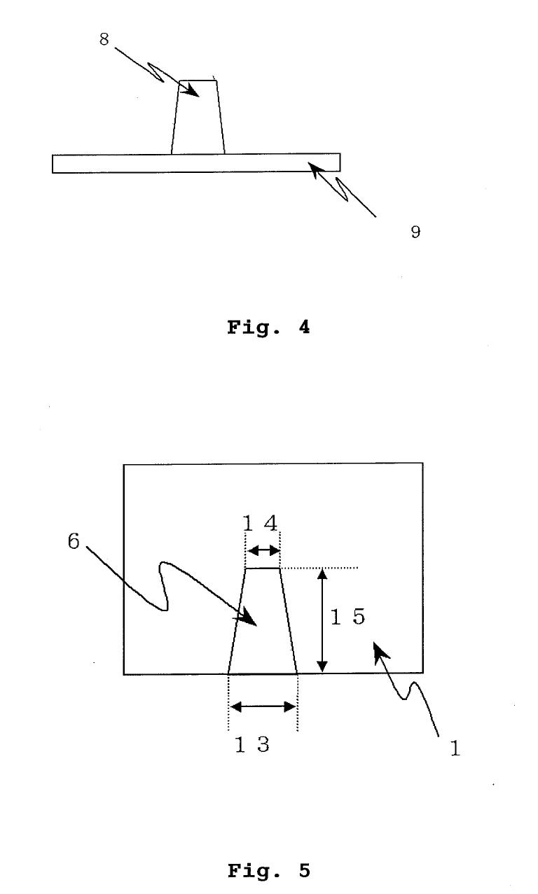

The supply of the compressed gas was stopped and, 5 seconds later, molten polypropylene (NOBLEN BUE81E6, manufactured by Sumitomo Chemical Co., Ltd., MFR=80 g/10 min) was supplied into the cavity through the resin passage (5) in the first mold (11) at arate of 3 g/min for 2.5 seconds. Thus, the cavity was filled up with the molten polypropylene. As a result, a molded article comprising a foamed substrate and a polypropylene rib joined thereto was formed. After cooling by blowing the air with a fan, the molds were opened and the molded article was taken out. By cutting unnecessary parts away, a flat plate (9) with a rib (8) shown in FIG. 3 was obtained. There was no recess in the surface opposite to the rib; the ribbed flat plate had good appearance.

### Comparative Example

A ribbed flat plate was produced in the same manner as Example 1 by using a foamed sheet, thermoplastic resin and molds the same as those used in Example 1, except supplying no compressed air into the cavity. The resulting ribbed flat plate had a groove-like recess in the surface opposite to its rib; it had poor appearance.

What is claimed is:

1. A method for producing a molded article comprising a thermoplastic resin foamed substrate and a thermoplastic resin functional member which is joined to and projects from the foamed substrate, the method comprising the following steps (1) to (8) that are executed by use of a molding machine comprising a first mold which has a first mold surface having a recessed portion defining a cavity for forming the functional member therein and which is configured so that compressed gas and thermoplastic resin in a molten state can be supplied into the cavity and a second mold which has a second mold surface and which is arranged so that the second mold surface faces the first mold surface:
(1) a step of placing a foamed substrate made of thermoplastic resin between the first mold and the second mold;
(2) a step of supplying a compressed gas into the cavity;
(3) a step of closing the first mold and the second mold while the foamed substrate is located between the first mold and the second mold;
(4) a step of bringing the foamed substrate into contact with a portion other than the recessed portion of the first mold surface, thereby closing the cavity with the foamed substrate and the first mold surface;
(5) a step of stopping the supply of the compressed gas into the cavity;
(6) a step of supplying a thermoplastic resin in a molten state into the cavity to join it to the foamed substrate by welding and simultaneously form a functional member from the thermoplastic resin, thereby forming a molded article comprising the foamed substrate and the functional member joined thereto;
(7) a step of stopping the supply of the thermoplastic resin in a molten state into the cavity; and
(8) opening the first mold and the second mold and taking out the molded article.

2. The method according to claim 1, wherein steps (2), (3) and (4) are executed simultaneously.
